(19) United States
(12) Patent Application Publication
(10) Pub. No.: US 2026/0208170 A1
(43) Pub. Date: Jul. 23, 2026

(54) PREPARATION METHOD OF DOUBLE METAL CYANIDE CATALYST FOR PREPARING A POLYCARBONATE-ETHER

(71) Applicant: PTT GLOBAL CHEMICAL PUBLIC COMPANY LIMITED, Bangkok (TH)

(72) Inventors: Khamphee PHOMPHRAI, Bangkok (TH); Phongnarin CHUMSAENG, Bangkok (TH); Supajittra YIMTHACHOTE, Bangkok (TH); Anupat POTISATITYUENYONG, Bangkok (TH); Chutamart PITAKCHATWONG, Bangkok (TH)

(21) Appl. No.: 19/139,091

(22) PCT Filed: Aug. 18, 2023
(86) PCT No.: PCT/IB2023/058266

§ 371 Date: Jun. 13, 2025

(30) Foreign Application Priority Data
Dec. 28, 2022 (TH) 2201008518

(51) Int. Cl. B01J 27/26; B01J 37/04; C08G 64/34

(52) U.S. Cl. CPC B01J 27/26; B01J 37/04; C08G 64/34

(57) ABSTRACT

The present invention relates to a preparation method of double metal cyanide catalyst for producing a polycarbonate-ether from epoxide and carbon dioxide, wherein said process comprises the following steps:
(a) mixing of a metal salt selected from zinc (II) metal salt, iron (II) metal salt, cobalt (II) metal salt, nickel (II) metal salt, metal cyanide salt, and the first complexing agent selected from alcohol compounds, ketone and diketone compounds, ketone-ester compounds, ether compounds, or a mixture thereof at predetermined time and temperature to obtain double metal cyanide catalyst precursor; and
(b) subjecting the double metal cyanide catalyst precursor obtained from step (a) to react with the second complexing agent selected from aliphatic carbonyl compound, aliphatic ester ether compound, or a mixture thereof in water or organic solvent at a predetermined time and temperature to obtain the double metal cyanide catalyst.

### TECHNICAL FIELD

The present invention relates to the preparation method of double metal cyanide catalyst for preparing a polycarbonate-ether.

### BACKGROUND ART

Up to the present, the release of greenhouse gases, especially carbon dioxide has been increasing continuously. This is the main reason for the increasing global temperature causing global warming, which also affects climate change. Therefore, many business segments from all over the world are collaborating to promote decarbonization in environmental policy. The most important aim is net zero emission. The development of a catalyst for producing linear polycarbonate or aliphatic polycarbonate products is one of the alternative methods that can generate value from the use of carbon dioxide.

Polycarbonate is classified as a thermoplastic polymer consisting of a carbonate functional group (—O(CO)O—) as its chemical composition. Aliphatic polycarbonate is one of the important biodegradable polymers that are incredibly useful in wide applications depending on the type of polycarbonate. For example, poly(propylene carbonate) has been used in coatings, biomedical applications, or packaging applications, etc.

Normally, the linear polycarbonate can be synthesized by ring-opening copolymerization of epoxide compounds such as propylene oxide and carbon dioxide under catalytic conditions. The catalyst commonly used can be divided into two types: the homogeneous catalysts containing the complex compound of chromium (III), cobalt (III), aluminum (III), and zinc (II), and the heterogeneous catalysts such as zinc gluconate and double metal cyanide catalyst.

However, the preparation of the homogeneous catalyst is more complicated and required more steps than the preparation of the heterogeneous catalyst. Moreover, the obtained polymer may be contaminated with metal which is difficult for further removal. This can be seen from the color of the obtained polymer. Therefore, the heterogeneous catalyst is suitable for the production of polycarbonate in industry because it is colorless, easy to handle, has reusability, and lower cost of production.

A double metal cyanide heterogeneous catalyst is an effective catalyst for producing polycarbonate from epoxide and carbon dioxide. Normally, this catalyst can be prepared from the reaction of a metal salt such as zinc chloride (ZnCl₂) and metal cyanide salt such as potassium hexacyanocobaltate (III). However, the double metal cyanide catalyst without the complexing agents or being called Prussian blue is not effective in a ring-opening copolymerization. Therefore, the development of the metal cyanide salt catalyst requires the complexing agent as the composition.

Wang et., al. (European polymer journal 2011, 47, 2152-2157) discloses the preparation of zinc hexacyanocobaltate having tert-butanol as the complexing agent for the ring-opening copolymerization of propylene oxide and carbon dioxide. From the experiment of the reaction at the temperature of 90° C. for 10 hours at carbon dioxide pressure of 40 bars, it was found that this catalyst gave yield of 60 kg of polymer per 1 g of the catalyst. The obtained polypropylene carbonate-ether has an average molecular weight of 130 kg/mole. The carbonate content in the polymer was 34 to 49%. It also found that propylene carbonate is a by-product at less than 1.0% by weight.

Zhang et., al. (Polymer 2011, 52, 5494-5502) discloses the preparation of nano-lamellar zinc hexacyanocobaltate catalyst using tert-butanol as the complexing agent for the synthesis of polypropylene from the ring-opening copolymerization of propylene oxide and carbon dioxide. From the experiment of the reaction at the temperature of 60° C. for 10 hours at carbon dioxide pressure of 50 bars, it was found that this catalyst gave yield of 6.05 kg of polymer per 1 g of the catalyst. The obtained polypropylene carbonate-ether has the average molecular weight (Mₙ) of 36.5 kg/mole. The molecular weight distribution was 2.0. The carbonate content in the polymer was high as 72.6%.

Darbha et., al. (Applied Catalysis A: General 2014, 482, 300-308) discloses the preparation of zinc hexacyanocobaltate catalyst using tert-butanol as the complexing agent for the synthesis of polycyclohexene carbonate from the ring-opening copolymerization of cyclohexene oxide and carbon dioxide. From the experiment of the reaction at the temperature of 75° C. for 11 hours at carbon dioxide pressure of 30 bars, it was found that this catalyst gave yield of 52.8 kg of polymer per 1 g of the catalyst without induction period. The obtained polymer has an average molecular weight of 20.9 kg/mole. The molecular weight distribution was 1.8. The carbonate content in the polymer was 86%.

U.S. Pat. No. 5,482,908B2 discloses the preparation of the highly catalytic double metal cyanide catalyst for the polymerization of an epoxide. Said method comprises the preparation of the double metal cyanide catalyst of zinc hexacyanocobaltate under the condition having tert-butanol as the complexing agent and polyether having the average molecular weight of more than 500 g/mole as the co-complexing agent which helps in phase development and reduced the crystallization of the catalyst. The obtained solid double metal cyanide catalyst contained about 5 to 80% by weight of said polyether.

U.S. Pat. No. 9,605,111B2 discloses the preparation of the double metal cyanide catalyst having a higher reaction rate for polymerization in the synthesis of polyether polyol. Said method comprises: a) synthesis of solid double metal cyanide catalyst under a condition with an organic complexing agent and polyether polyol ligand have an average molecular weight of less than 2000 g/mole; and b) subjecting the obtained catalyst to washing with an aqueous solution containing 90 to 100% by weight of water and 0 to 10% by weight of polyether polyol in which the aqueous solution contains no organic complexing agent.

U.S. Pat. No. 10,619,006B2 discloses the preparation of the double metal cyanide catalyst for polymerization of polycarbonate polyol. Said method comprises the preparation of the double metal cyanide catalyst of zinc hexacyanocobaltate under the condition with the complexing agents having acetate and tartrate. The salt ratio of metal to complexing agent was 1:5 to 1:10 by weight. The polyether polyol ligand was 0.1 to 30 parts per weight of the double metal cyanide catalyst. The catalyst obtained from this invention had high effectiveness in the production of polycarbonate using the environmentally friendly complexing agent. The reaction was performed rapidly with a low induction time. Nevertheless, the catalyst obtained from this invention and the one disclosed in Korean patent no. 10-2012-0042796 that used lactate compound as the complexing agent and in Korean patent no. 10-2014-0042167 that used ketone and alcohol-containing compounds as the complexing agent, all above-mentioned could not control the specificity in the synthesis of polycarbonate at high level.

From all above, the use of tert-butanol complexing agent is suitable and effective for the preparation of the double metal cyanide catalyst. There have been attempts to improve the properties of the catalyst using a co-complexing agent such as a polyether polyol or the use of other complexing agents instead of tert-butanol, but so far said methods are ineffective when compared with the tert-butanol as the complexing agent in term of induction time, and specificity of the polymer at high level. Moreover, the previous disclosures require mixing the complexing agent and/or co-complexing agent together with the double metal cyanide catalyst. This causes complexity in the development and preparation of the catalyst because the changing of the complexing agents is complicated due to the need of restarting all the synthesis steps.

This invention aims to provide the preparation method of the double metal cyanide catalyst for producing the polycarbonate-ether from epoxide and carbon dioxide which is convenient in the changing of the complexing agent. Moreover, this invention demonstrates a novel method for improving the properties of the catalyst by using the second complexing agent prepared from tert-butanol as the first complexing agent. The improvement of the catalyst can be done easily and provide a variety of the structure of the catalyst and increases the effectiveness in the production of the polycarbonate-ether in term of yield, induction time, and specificity in controlling of the polymer synthesis.

### SUMMARY OF INVENTION

The present invention relates to the preparation method of a double metal cyanide catalyst for producing a polycarbonate-ether from epoxide and carbon dioxide which is easy to adjust of the complexing agent and more effective in the production of polycarbonate-ether from epoxide and carbon dioxide. Said process is comprising the following steps:
(a) mixing of metal salt selected from zinc (II) metal salt, iron (II) metal salt, cobalt (II) metal salt, nickel (II) metal salt, metal cyanide salt, and the first complexing agent selected from alcohol compounds, ketone and diketone compounds, ketone-ester compounds, ether compounds, or a mixture thereof at predetermined time and temperature to obtain double metal cyanide catalyst precursor; and
(b) subjecting the double metal cyanide catalyst precursor obtained from step (a) to react with the second complexing agent selected from aliphatic carbonyl compound, aliphatic ester ether compound, or a mixture thereof in water or organic solvent at predetermined time and temperature to obtain the double metal cyanide catalyst.

### BRIEF DESCRIPTION OF THE FIGURES

FIG. 1 is the graph showing the analytical of the catalyst by X-ray diffraction (XRD) technique of: a) comparative catalyst 1; b) comparative catalyst 2; c) comparative catalyst 3; d) catalyst according to the invention 1; e) catalyst according to the invention 2; and f) catalyst according to the invention 3.

### DETAILED DESCRIPTION

The present invention relates to the preparation method of a double metal cyanide catalyst for producing a polycarbonate-ether from epoxide and carbon dioxide which is easy to adjust of the complexing agent. The catalyst according to the invention can catalyze the production of the polycarbonate-ether from epoxide and carbon dioxide effectively. The preparation method according to the invention can be described as the following.

Any aspect demonstrated herein is meant to include the other application of this invention unless stated otherwise.

Technical terms or scientific terms used here have definitions by a person skilled in the art unless stated otherwise.

Any tools, equipment, methods, or chemicals named here mean tools, equipment, methods, or chemicals being used commonly by a person skilled in the art unless stated otherwise that they are tools, equipment, methods, or chemicals specific only to this invention.

Use of singular noun or singular pronoun with “comprising” in claims or specification means “one” and including “one or more”, “at least one”, and “one or more than one” too.

All compositions and/or methods disclosed and claims in this application aim to cover embodiments from any action, performance, modification, or adjustment without any experiment that is significantly different from this invention and obtain with the object with utility and resulted as same as the present embodiment according to a person ordinary skilled in the art although without specifically stated in claims. Therefore, substitutable, or similar objects to the present embodiment, including any little modification or adjustment that is clearly seen by a person skilled in the art should be construed as remains in spirit, scope, and concept of invention as appeared in appended claims.

Throughout this application, the term “about” means any number that appeared or showed here that could be varied or deviated from any error of equipment, method, or person using said equipment or method.

Hereafter, invention embodiments are shown without any purpose to limit any scope of the invention.

This invention relates to the preparation method of the double metal cyanide catalyst for producing a polycarbonate-ether from epoxide and carbon dioxide effectively and specifically to the formation of polycarbonate-ether. Said preparation method of the catalyst comprises the following steps:
(a) mixing of a metal salt selected from zinc (II) metal salt, iron (II) metal salt, cobalt (II) metal salt, nickel (II) metal salt, metal cyanide salt, and the first complexing agent selected from alcohol compounds, ketone and diketone compounds, ketone-ester compounds, ether compounds, or mixture thereof at predetermined time and temperature to obtain double metal cyanide catalyst precursor; and
(b) subjecting the double metal cyanide catalyst precursor obtained from step (a) to react with the second complexing agent selected from aliphatic carbonyl compound, aliphatic ester ether compound, or a mixture thereof in water or organic solvent at predetermined time and temperature to obtain the double metal cyanide catalyst.

In one aspect of the invention, the first complexing agent is tert-butanol.

In one aspect of the invention, the second complexing agent is selected from 2,5-hexanedione, methyl methoxy acetate, methyl-3-methoxy propionate, or a mixture thereof.

In one aspect of the invention, a metal salt is selected from zinc (II) chloride, zinc (II) bromide, zinc (II) acetate, zinc (II) acetonyl acetate, zinc (II) nitrate, iron (II) sulfate, iron (II) bromide, cobalt (II) chloride, cobalt (II) thiocyanate, nickel (II) nitrate, or mixture thereof. In one aspect of the invention, metal salt is zinc (II) chloride (ZnCl₂).

In one aspect of the invention, metal cyanide salt is selected from potassium hexacyanocobaltate (III), potassium hexacyanoferrate (III), calcium hexacyanocobaltate (III), or a mixture thereof.

In one aspect of the invention, the metal cyanide salt is potassium hexacyanocobaltate (III).

In one aspect of the invention, the mole ratio of metal salt to metal cyanide salt in step (a) is from 1:1 to 20:1.

In one aspect of the invention, the mole ratio of metal salt to metal cyanide salt in step (a) is from 5:1 to 10:1.

In one aspect of the invention, the preparation process is operated under temperature from 20 to 100° C., preferably 40 to 70° C.

In some aspects of the invention, the preparation method of polycarbonate-ether comprises the following steps:
(a) subjecting the double metal cyanide catalyst according to any one of claims 1 to 11 to the reactor, adding the polymer polyol, epoxide, and carbon dioxide at the predetermined pressure, heating at the temperature from 50 to 120° C., and the pressure of carbon dioxide is from 1 to 40 bars; and
(b) removing the mixture obtained from step (a) out of the reactor and separating the polycarbonate-ether product from the mixture.

In some aspects of the invention, the synthesis process of polycarbonate-ether is operated at the temperature from 70 to 100° C., and the pressure of carbon dioxide is from 5 to 20 bars.

In some aspects of the invention, the mole ratio of polymer polyol and epoxide is from 1:5 to 1:4,000.

Generally, a person skilled in this art can modify the ring-opening copolymerization between epoxide compound and carbon dioxide to be suitable for type and composition of the catalyst. The following examples are only for demonstrating one aspect of this invention, not for limiting the scope of this invention in any way.

### Preparation of the Catalyst

The preparation of the catalyst may be done by the following method.

### Comparative Catalyst 1

The comparative catalyst 1 can be prepared by mixing zinc (II) chloride solution (manufactured by DAEJUNG) and potassium hexacyanocobaltate (III) solution (manufactured by ACROS ORGANICS) in water at the ratio of 8:1 by mole. Then, said solution was stirred turbulently at the temperature of 40 to 70° C. The white precipitate was separated and dried. The comparative catalyst 1 was obtained as a white solid.

### Comparative Catalyst 2

The comparative catalyst 2 was prepared according to the steps disclosed by Srinivas et., al. (Applied Catalysis A: General, 2014, 482, 300-308).

The comparative catalyst 2 was prepared by mixing tert-butanol solution (manufactured by LOBA CHEMIE PVT) in water (ratio of 50:50) into the comparative catalyst 1 at the temperature of 40 to 70° C. at the ratio of 8:1 by mole. The white precipitate was separated and dried. The comparative catalyst 2 was obtained as a white solid.

### Comparative Catalyst 3

The comparative catalyst 3 was prepared according to the steps disclosed by Kim et., al. (Catalysis Today, 2021, 375, 335-342).

The comparative catalyst 3 was prepared by mixing zinc (II) chloride solution (manufactured by DAEJUNG) and 2,5-hexane dione compound (manufactured by Sigma-Aldrich) in water at the ratio of 2.25:1 by mole). Then, potassium hexacyanocobaltate (III) solution (manufactured by ACROS ORGANICS) in water was mixed into said solution at the temperature of 50° C. The ratio of zinc (II) chloride to potassium hexacyanocobaltate (III) was 6:1 by mole. The mixture containing pluronic (P-123) (manufactured by SIGMA-ALDRICH) and 2,5-hexane dione compound were added at the ratio of 1:460 by mole. The white precipitate was separated and dried. The comparative catalyst 3 was obtained as a white solid.

### Catalyst According to the Invention 1

The catalyst according to the invention 1 can be prepared by subjecting the catalyst prepared by the method according to the comparative catalyst 2 to be added with 2,5-hexane dione (manufactured by SIGMA-ALDRICH) in distilled water (concentration of 0.9 molars) at the ratio of 1 g of catalyst to 20 mL of complexing agent solution at the temperature of 50° C. Then, the white precipitate was separated and dried. The catalyst according to the invention 1 was obtained as a white solid.

### Catalyst According to the Invention 2

The catalyst according to the invention 2 can be prepared by the method according to the catalyst according to the invention 1 except that methyl methoxy acetate (manufactured by Tokyo Chemical Industry) was used as the complexing agent.

### Catalyst According to the Invention 3

The catalyst according to the invention 3 can be prepared by the method according to the catalyst according to the invention 1 except that methyl-3-methoxy propionate (manufactured by Tokyo Chemical Industry) was used as the complexing agent.

### Testing of the Effectiveness of Polymerization for the Production of Polycarbonate-Ether

The comparative catalyst and the catalyst according to the invention were tested for their capability in the production of polycarbonate-ether. The testing conditions are described as below.

The catalysts as described in Table 1 were added to the reactor. Polypropylene glycol having molecular weight of 425 g/mole (manufactured by SIGMA-ALDRICH) and propylene oxide (manufactured by SIGMA-ALDRICH) were added at ratio of 1:200 by mole of polypropylene glycol to propylene oxide. Then, carbon dioxide was added till the pressure reached 10 bars. The temperature was heated to about 80 to 100° C. for 1 to 3 hours. The reaction was monitored by nuclear magnetic resonance to quantify cyclic carbonate content which was a by-product. At the end of the reaction, the temperature was reduced to room temperature. The obtained polymer was washed with water to remove propylene carbonate and dried to obtain the polycarbonate-ether.

Table 1 shows the production of polycarbonate-ether from carbon dioxide and epoxide by the
reaction prepared by the comparative catalyst and the catalyst according to the invention.

| | | Cyclic | Carbonate | Number Average | | |
|---|---|---|---|---|---|---|
| | Conversion | carbonate^{b} | content in | Molecular | | Yield (kg of |
| | of propylene | (% by | polymer^{b} | Weight, Mn)^{c} | Dispersity, | polymer/g |
| Catalyst | oxide (%) | weight) | (% mole) | (Dalton) | (Ð)^{c} | of catalyst) |
| Comparative | 0.00 | — | — | — | — | 0.00 |
| catalyst 1 | | | | | | |
| Comparative | 88.60 | 2.20 | 19.80 | 13,875 | 2.99 | 1.53 |
| catalyst 2 | | | | | | |
| Comparative | 53.20 | 36.50 | 31.00 | 8,674 | 2.67 | 0.81 |
| catalyst 3 | | | | | | |
| Catalyst | 97.70 | 5.30 | 16.40 | 9,605 | 2.56 | 1.65 |
| according to | | | | | | |
| the invention 1 | | | | | | |
| Catalyst | 89.40 | 2.70 | 13.90 | 6,856 | 1.72 | 1.50 |
| according to | | | | | | |
| the invention 2 | | | | | | |
| Catalyst | 100 | 1.80 | 19.60 | 11,904 | 2.19 | 1.77 |
| according to | | | | | | |
| the invention 3 | | | | | | |

^{a}Experimental condition: temperature was 90° C., carbon dioxide pressure was 10 bars, and propylene oxide to polypropylene glycol reaction precursor was 200;
^{b}Calculated from proton nuclear magnetic resonance spectroscopy technique;
^{c}Results from gel permeation chromatography (GPC) technique using polystyrene as compared standard

Testing with Proton Nuclear Magnetic Resonance Spectroscopy Technique

Ten milligrams of polymer were dissolved in chloroform-d solution and analyzed with nuclear magnetic resonance (Bruker, AV III HD-600 MHz). The obtained graph was compared with reference chemical shifts (δ) of remaining proton of chloroform-d (δ=7.26 ppm).

Testing with Gel Permeation Chromatography

Fifteen milligrams of polymer were dissolved in 5 mL of tetrahydrofuran (THF) solution. Then, they were filtered through 0.22 μm polytetrafluoroethyl filter (PTFE filter) and analyzed with gel permeation chromatography (Malvern, Viscotek GPCmax TDA 305) connected to 300 mm×8.0 mm i.d. column containing porous copolymer styrene divinyl benzene. The testing conditions were as followings. The flow rate was 1.0 mL/min. The temperature was 35° C. Tetrahydrofuran was used as the mobile phase. The obtained molecular weight and dispersibility of the molecular weight were compared with 1,200 to 300,000 daltons of polystyrene standard.

Testing with Powder X-Ray Diffraction (XRD)

Samples were ground into powder with ceramic mortar and pressed into silicon mold to have smooth surface and analyzed with powder X-ray diffraction (Bruker, D8 ADVANCE). Cu Kα was used as the radiation source at λ=1.5406 Å. It increased 0.02 degrees from 5 degrees to 70 degrees at the rate of 1 degree per minute.

### Testing Results of the Catalysts

Table 1 shows the results of comparative catalysts and catalysts according to the invention. It shows that the catalysts according to the invention had a higher reaction rate than the comparative catalysts determined from the conversion of propylene oxide. The catalysts according to the invention provided a higher conversion rate than the comparative catalysts.

Moreover, when comparing the catalyst according to the invention 1 to comparative catalyst 3 which was the catalyst that similarly used 2,5-hexane dione as the complexing agent but with different preparation steps of the catalyst, it was found that the catalyst according to the invention provided better effectiveness in the synthesis of polycarbonate-ether. The conversion percentage of propylene oxide and polymer yield per gram of the catalyst was higher than the comparative catalyst. The formation of cyclic carbonate as by-product was also much lower (5.3% for catalyst according to the invention 1 and 36.5% for comparative catalyst 3).

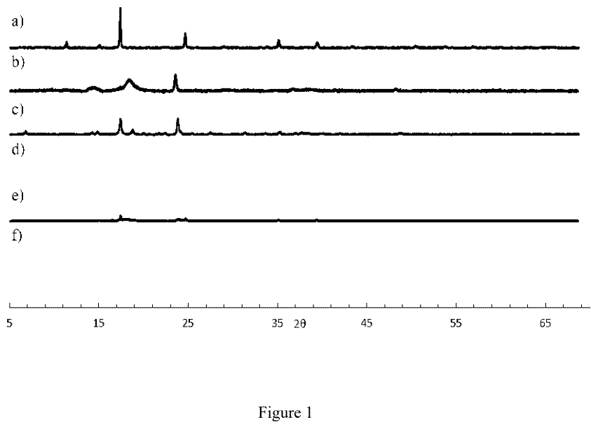

Moreover, from powder X-ray diffraction (shown in FIG. 1), it was confirmed that all three catalysts according to the invention have a phase change in molecular structure when compared with the catalysts before the treatment (comparative catalyst 2). Moreover, these results were differentiated depending on the types of complexing agents, which confirmed that the method according to this invention can modify the internal structure of catalysts according to the selected complexing agent.

From all above, it is shown that the preparation method of the double metal cyanide catalyst according to the invention using the second complexing agent for improving the properties of catalyst can be easily performed and makes convenient modification of the other complexing agents. It is a time saving in the preparation of the catalyst and only require small amount of the complexing agent compared to the previously disclosed methods. Moreover, this can increase the effectiveness in the production of the polycarbonate-ether than commonly used catalysts in term of yield and specificity of the polymer at a high level.

### PREFERRED EMBODIMENT OF THE INVENTION

The preferred embodiment of the invention is as provided in the description of the invention.

1. A preparation method of double metal cyanide catalyst for preparing a polycarbonate-ether, wherein said method comprising the following steps:
(a) mixing of metal salt selected from zinc (II) metal salt, iron (II) metal salt, cobalt (II) metal salt, nickel (II) metal salt, metal cyanide salt, and the first complexing agent selected from alcohol compounds, ketone and diketone compounds, ketone-ester compounds, ether compounds, or mixture thereof at predetermined time and temperature to obtain double metal cyanide catalyst precursor; and
(b) subjecting the double metal cyanide catalyst precursor obtained from step (a) to react with the second complexing agent selected from aliphatic carbonyl compound, aliphatic ester ether compound, or mixture thereof in water or organic solvent at predetermined time and temperature to obtain the double metal cyanide catalyst.

2. The preparation method of catalyst according to claim 1, wherein the first complexing agent is tert-butanol.

3. The preparation method of catalyst according to claim 1, wherein the second complexing agent is selected from 2,5-hexanedione, methyl methoxy acetate, methyl-3-methoxy propionate, or a mixture thereof.

4. The preparation method of catalyst according to claim 1, wherein metal salt is selected from zinc (II) chloride, zinc (II) bromide, zinc (II) acetate, zinc (II) acetonyl acetate, zinc (II) nitrate, iron (II) sulfate, iron (II) bromide, cobalt (II) chloride, cobalt (II) thiocyanate, nickel (II) nitrate, or a mixture thereof.

5. The preparation method of catalyst according to claim 1, wherein metal salt is zinc (II) chloride (ZnCl₂).

6. The preparation method of catalyst according to claim 1, wherein metal cyanide salt is selected from potassium hexacyanocobaltate (III), potassium hexacyanoferrate (III), calcium hexacyanocobaltate (III), or a mixture thereof.

7. The preparation method of catalyst according to claim 1, wherein metal cyanide salt is potassium hexacyanocobaltate (III).

8. The preparation method of catalyst according to claim 1, wherein the mole ratio of metal salt to metal cyanide salt in step (a) is from 1:1 to 20:1.

9. The preparation method of catalyst according to claim 1, wherein the mole ratio of metal salt to metal cyanide salt in step (a) is from 5:1 to 10:1.

10. The preparation method of catalyst according to claim 1, wherein the preparation process is operated under temperature from 20 to 100° C.

11. The preparation method of catalyst according to claim 1, wherein the preparation process is operated under temperature from 40 to 70° C.

12. A method for producing polycarbonate-ether, wherein said method comprising the following steps:
(a) subjecting the double metal cyanide catalyst according to any one of claims 1 to 11 to the reactor, adding the polymer polyol, epoxide, and carbon dioxide at the predetermined pressure, heating at the temperature from 50 to 120° C., and pressuring carbon dioxide from 1 to 40 bars; and
(b) removing the mixture obtained from step (a) from the reactor and separating polycarbonate-ether product from the mixture.

13. The method for producing of polycarbonate-ether according to claim 12, wherein the reaction is operated at the temperature from 70 to 100° C., and the pressure of carbon dioxide is from 5 to 20 bars.

14. The method for producing of polycarbonate-ether according to claim 12, wherein the mole ratio of polymer polyol and epoxide is from 1:5 to 1:4,000.

15. The catalyst obtained from the preparation method of catalyst according to claim 1.
